(19) United States
(12) Patent Application Publication
(10) Pub. No.: US 2013/0180161 A1
(43) Pub. Date: Jul. 18, 2013

(54) BED BUG TRAP WITH INDICATION OF BED BUG SOURCE

(71) Applicant: Bug Elimination and Prevention Corporation, Waterloo (CA)

(72) Inventors: Kailash C. Vasudeva, Waterloo (CA); Satnam Singh, Kitchener (CA)

(73) Assignee: BUG ELIMINATION AND PREVENTION CORPORATION, Waterloo (CA)

(21) Appl. No.: 13/742,416

(22) Filed: Jan. 16, 2013

Related U.S. Application Data
(60) Provisional application No. 61/587,265, filed on Jan. 17, 2012.

(51) Int. Cl. A01M 1/10; A01M 1/14

(52) U.S. Cl. CPC A01M 1/103; A01M 1/14
USPC 43/114; 43/123

(57) ABSTRACT

The bed bug trap has more than one trapping area, each trapping area associated with one or more discrete bed bug sources, such that finding a bed bug in one particular trapping area indicates that the bed bug must have arrived there from one or more specific sources, whereas finding a bed bug in another particular trapping area indicates that the bed bug must have arrived there from one or more other specific sources. The bed bug trap may also be provided with bed bug attracting means, which may include heat, and/or chemical attractants, and/or carbon dioxide. In some embodiment, the bottom surface of the trapping area may be sloped towards one or more accumulation areas for easier inspection.

### REFERENCE TO RELATED APPLICATION

This is a formal application based on and claiming the benefit of provisional application Ser. No. 61/587,265 filed Jan. 17, 2012.

### BACKGROUND OF THE INVENTION

1. Field of the Invention

This invention relates to detection and control or ideally elimination of bed bugs, and potentially other arthropods.

For convenience, reference will be made only to bed bugs, but it should be considered that the principles of the invention may be applicable to other arthropods.

2. Description of the Prior Art

There are existing bed bug traps which are positionable under a bedpost or under the leg of another type of furniture. For convenience, reference will be made simply to bedposts throughout this application, but it should be understood that the principle applies to any piece of furniture.

In some traps, any bed bugs which descend the bed post cannot climb into the trapping area from the bottom of the bed post, those traps being designed to capture only bed bugs arriving via the surrounding floor. However, in other traps, such as the own shown in international patent application no. PCT/CA2011/001052, entitled “Bed Bug Detection and Control”, bed bugs can arrive from the bedpost, or from the surrounding floor area. In such a trap, there is a smooth-walled annular channel around the bedpost, having a textured outer surface which bed bugs can climb from the surrounding floor, and a textured inner surface which bed bugs can climb from the area containing the bedpost. Once the bed bugs climb the textured surface, they then drop into the channel, from which they are unable to escape due to the smooth surfaces of the walls which define the channel. It is well known that bed bugs can climb sufficiently textured surfaces, and that they cannot climb sufficiently smooth surfaces.

However, with existing traps of this type, when a bed bug is captured, there is no way of knowing whether that bed bug arrived in the channel from the bed, i.e. via the area of the bedpost, or from the floor surrounding the bedpost.

It would be desirable, when finding a bed bug in the trap, to know whether that bed bug came from the bed or from the surrounding floor.

Similarly, in any other bed bug trapping device or situation where more than one source for the bed bugs is possible, it would be desirable to know which source the bed bug arrived at the trap from.

### SUMMARY OF THE INVENTION

In view of the above, it is an object of this invention to provide a bed bug trap that has the capability of indicating the source of the bed bugs.

Therefore, in the invention, the bed bug trap has more than one trapping area, each trapping area associated with one or more discrete bed bug sources. That is, finding a bed bug in one particular trapping area indicates that the bed bug must have arrived there from one or more specific sources, whereas finding a bed bug in another particular trapping area indicates that the bed bug must have arrived there from one or more other specific sources.

The invention is not limited to bed bug traps of the type referred to above, i.e. those intended to be placed under a bedpost or the like. However, one specific embodiment does relate to bed bug traps of that type. In accordance with the invention, the channel is divided into two trapping areas, by virtue of two dividers. The outer surface of the outer wall of the trap is textured only adjacent one of the trapping areas, so that if a bed bug is found in that trapping area, the user knows that the bed bug came from outside the trap, i.e. from the surrounding floor. As for the inner surface of the inner wall of the trap, it is textured only adjacent the other trapping area, so that if a bed bug is found there, it must have come via the bedpost.

It should be apparent that the same principle could be applied where there are three or more potential sources, not just two.

Further details of the invention will be described or will become apparent in the course of the following detailed description and drawings of specific embodiments of the invention, as examples.

It should be apparent that the same principle could be applied where there are three or more potential sources, not just two.

In some preferred embodiments, the bed bug trap may also be provided with bed bugs attracting means, which may include heat, and/or chemical attractants (kairomones and/or pheromones), and/or carbon dioxide.

In one preferred embodiment, the bottom surface of the trapping area is sloped to one or more areas to accumulate trapped bed bugs for easier detection.

In other embodiments, the bed bug traps are configured to facilitate attachment to a vertical surface of a bed frame or other furniture.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is a perspective view of an exemplary embodiment of the bed bug trap;

FIG. 2 is a top view corresponding to FIG. 1;

FIG. 3 is a perspective view of the bed bug trap, sectioned to show the interior trapping passage and sliding elements;

FIG. 4 is a view of the bed bug trap with attracting means including heating, chemical attractants and carbon dioxide generation;

FIG. 5 is cross-sectional view of an exemplary embodiment of the bed bug trap, in which the bottom surface of the trapping area is sloped;

FIG. 6 is a top view of the trap of FIG. 5;

FIG. 7 is a perspective view of an exemplary embodiment of a bed bug trap configured for attachment to the vertical surface of a bed or other item of furniture;

FIG. 8 is a cross-sectional view of the trap of FIG. 7;

FIG. 9 is a top view of an exemplary embodiment of a trap, showing glue clips on the bottom of the trapping area;

FIG. 10 is a cross-sectional view of the trap of FIG. 9; and

FIG. 11 is a perspective view of an exemplary embodiment of the glue clip used in FIGS. 9 and 10.

### DETAILED DESCRIPTION OF THE INVENTION

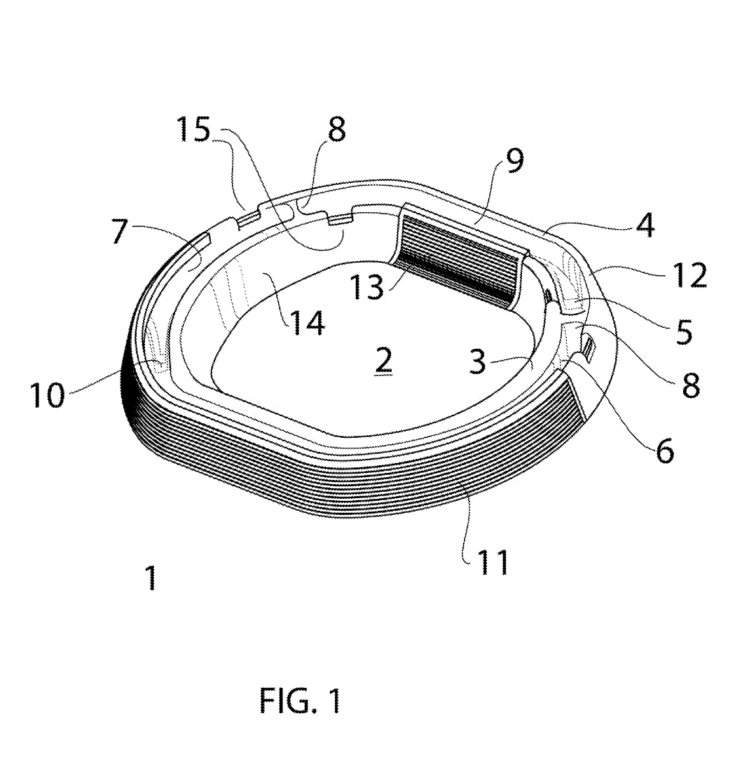

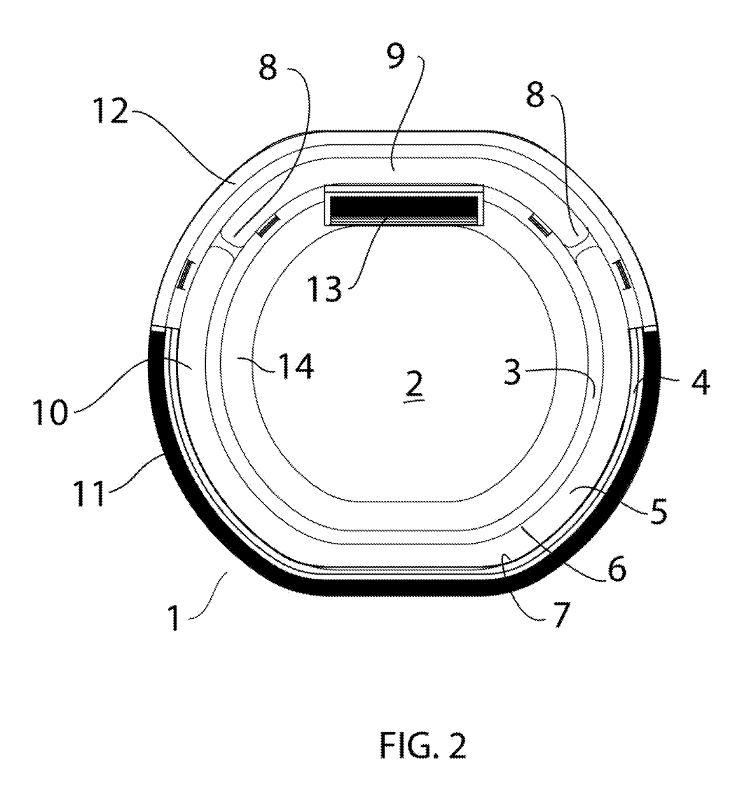

FIGS. 1 and 2 show a coaster-style trap 1 according to the invention. The trap has a flat central area 2 for receiving a bedpost (not shown) or other similar furniture element. Outside the flat central area is an inner wall 3 and an outer wall 4. An annular channel 5 is defined between the two walls. The outer surface 6 of the inner wall 3, and the inner surface 7 of the outer wall 4, are adequately smooth so the bed bugs cannot climb them, such that they are trapped in the channel 5.

In contrast to the prior art where the channel 5 is continuous, in this invention there are two dividers 8, which divide the trap channel into first and second trapping areas 9 and 10 respectively, which may be of equal size, or of different size as illustrated.

The outer surface of the outer wall 4 has a textured surface 11 only adjacent one of the trapping areas, namely trapping area 10 as illustrated, and has a smooth surface 12 elsewhere. The bed bugs approaching the trap from a surrounding floor area may climb the textured surface 11 in an attempt to get to the bed, and then fall into the trapping area 10 from which they are unable to escape. Thus, if bed bugs are found in that trapping area 10, the user knows that the bed bugs came from the outside of the trap, i.e. from the surrounding floor, via the textured surface 11. The inner surface of the inner wall 3 has a textured surface 13 only adjacent the other trapping area, namely trapping area 9 as illustrated, and has a smooth surface 14 elsewhere. If the bed bugs reach the flat central area 2 by coming down the bedpost, the bed bugs may climb the textured surface 13, and then fall into the trapping area 9. Thus, if bed bugs are found in trapping area 9, they must have come via the bedpost. Their origin must be the bed.

Preferably, the outer wall 4 and inner wall 3 are high enough and the channel 5 is deep enough that bed bugs can't climb out of the trapping area 9 and 10. The depth of the channel 5 could be 2 cm or more, or the depth of the channel 5 is 3 cm or more, such as 4 cm. Any person skilled in the art can adjust the depth of the channel.

The trap may be made of fairly rigid plastic material, such as high impact plastics or ABS plastic. It may also be made of cardboard, wax paper board, galvanized metal, aluminum, wood and so on.

Preferably, the inner surface 7 of the outer wall 4 and the outer surface 6 of the inner wall 3 are sloped, namely, the surface of 6 and 7 extends at angle of less than or equal to 90 degree from horizontal so that bed bugs on the top of the surface 6 and 7 may fall directly into the trap area, which is an advantage to trapping the bed bugs. Optionally, the cross section of channel 5 is U-shaped, V-shaped or similar, in order to prevent bed bugs climbing out of the trapping area.

The textured surface 11 and 13 is rough enough to facilitate entry of the bed bugs. It could be made from plastic, cardboard, wax paper board, or wood. The surface could have small crevices.

The textured surface 11 and 13 can be provided at an inclination that allows the bed bugs to travel up the textured surface 11 and 13 and get into the channel.

As illustrated, the textured areas 11 and 13 extend substantially the whole distance adjacent their respective trapping areas. However, it should be realized that the textured areas need not extend to that extent. They could, if desired, be somewhat smaller, though obviously it is desirable to provide the bed bugs with as much potential climbing surface as possible. On the other hand, if the textured surfaces extend too close to the dividers 8, it is conceivable that the bed bugs climbing immediately adjacent the edge of one of the textured surfaces could fall slightly sideways into the “wrong” trapping area. Therefore, preferably the textured areas do not extend all the way to the respective dividers.

It should be noted that in the embodiment as illustrated, the dividers are not as high as the walls which define the trapping channels. However, they obviously could be just as high, and they obviously do need to be high enough to prevent the bed bugs from climbing over them.

In above examples, the flat central area is used for receiving a bedpost or other furniture elements. The shape of the central area could be changed according to usage. For example, the central area could be big enough to receive bedposts or furniture legs that have a bigger footprint. For example, some beds have a complete box structured frame, then the trap could be design to be big enough to hold the frame; or if the beds have just the head board and foot board resting on the floor, then two traps could be used and each trap could be designed to receive the shape of the portions of the boards that make contact to the floor.

An additional feature of the preferred embodiment is that notches 15 are provided adjacent the dividers at the top of the inner wall 3 and outer wall 4. These notches are intended to prevent bed bugs from arriving at the top of one of the walls, and walking along the top of the walls before falling into the “wrong” trapping area. With these notches, if bed bugs crawl along the top of the wall from one of the textured surfaces and then down the ramped portion of the notch, they will be unable to climb up the smooth vertical portion of the notch to continue to the “wrong” area. It will either have to retrace its steps, or fall back to where it came from and recommence its journey, or preferably fall into the “right” trapping area.

As in the above-mentioned international patent application, preferably a space is provided beneath the trap channel, and the bottom surface of the channel has one or more holes through which the bed bugs can fall. Beneath those holes are removable and replaceable glue traps or the like, to capture the bed bugs which fall through the holes. The glue trap for one area is physically separated from the glue trap for the other area, so that there is no possibility of the bed bugs escaping or avoiding one glue trap and moving to the other glue trap, which would confuse the user as to the source of the bed bugs.

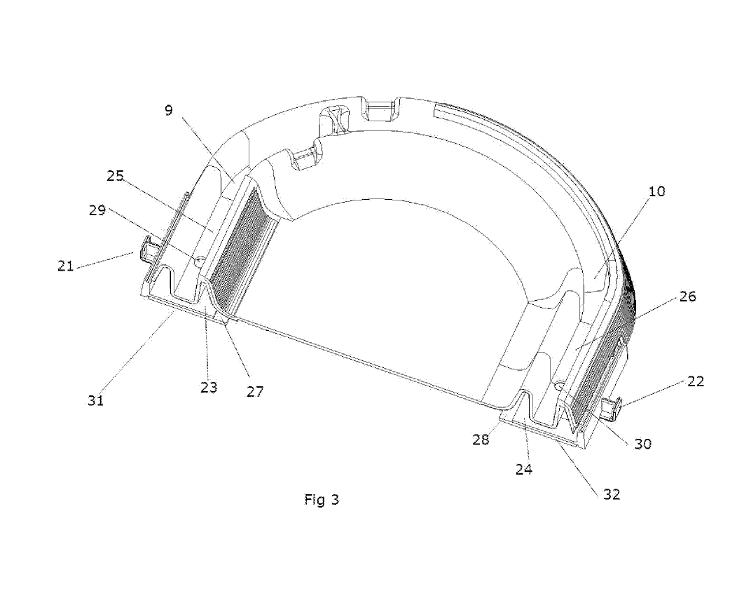

As seen best in FIG. 3, the trapping areas 9 and 10 preferably have elevated platform surfaces 25 and 26, with the area beneath the platform surface 25 and 26 having a lower surface 31 and 32 spaced below it and sealed to the trap such that there is a sealed passageway 27 between the platform surface 25 and the lower surface 31, and there is a sealed passageway 28 between the platform surface 26 and the lower surface 32.

However, one or more holes 29 and 30 through the platform surface 25 and 26 are provided (see FIG. 3), such that bed bugs in the trapping area 9 and 10 may fall through hole 29 or 30 and then find themselves in the sealed passageway 27 and 28. Since the trapping area 9 and 10, and the passageway 27 and 28 are separated, the bed bugs in the trapping area 9 can only fall on the passage 27 and bed bugs in the trapping area 10 can only fall on the passageway 28. Preferably, the elevated surface 25 and 26 are transparent, so that users can see if any bed bugs have been trapped. The trap therefore also acts as detection means, not just a trapping device.

Preferably, removable sliding elements 21 and 22 are provided, slidable in and out of the afore-mentioned trapping passageway 27 and 28, the passageway 27 and 28 being sealed when the sliding elements 21 and 22 are in position. The sliding elements have a flat surface 23 and 24, preferably generally aligned with the lower surface of the passageway 27 and 28, and that sliding element 21 and 22 preferably carries glue tape or other such means as may be established by routine experimentation to be effective in retaining bed bugs. The user may, if desired, remove and replace the sliding elements 21 and 22 from time to time, to dispose of captured bed bugs.

It is expected that any bed bugs making their way to the trapping areas 9 and 10 will eventually migrate to one of the holes 29 or 30, and from there will eventually migrate to the sliding elements 21 and 22 and be retained there.

Preferably, the bottom of the channel is transparent, or, at least the bottom of the channel in the area above the sliding elements 21 and 22 is transparent, so that users can see if any bed bugs have been trapped.

To increase the likelihood that bed bugs will encounter the monitor, attracting means can be provided in the trap. The attracting means could be attractant (pheromone/kairomones), Carbon Dioxide and/or Heat.

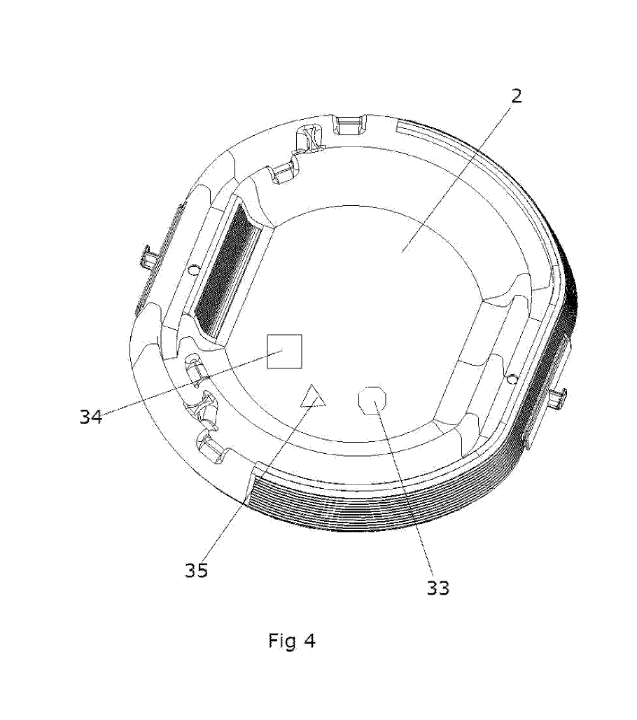

As shown in FIG. 4, an electric heating element 33 can be provided, as a thermal lure to further attract bed bugs toward the trap. The heating element 33 could be a chemical heating or an electrical heating element, or it can be provided as radiant heat or infrared heat.

As shown in FIG. 4, the electric heating element 33 is provided at the bottom of the flat center area 2 of the trap. It could be anywhere on the trap. It can be constructed so that it provides a temperature sufficient to attract insects, such as the temperature similar to the human body temperature. An exemplary temperature range that can be provided as a target temperature range is about 80° F. to about 100° F., as measured at the heating device surface.

As shown in FIG. 4, a carbon dioxide source 34 can be included in the trap. The carbon dioxide resource 34 can be a carbon dioxide generator, a carbon dioxide gas container, dry ice container or other known carbon dioxide generator. For example, the carbon dioxide source 34 can be a container, in which there are some chemical tablets that can produce carbon dioxide by adding water. Or the carbon dioxide source can be a stack of electrochemical cells that decompose organic carboxylated compounds into carbon dioxide. With carbon dioxide resource, the bed bug trap can be used as a quick bed bugs detection device. The carbon dioxide source 34 can be on the flat central area 2 as shown in FIG. 4, or placed on channel or the trapping area, or it can be connected to the device, by a pipe for example.

The trap may or may not include a bait or chemical attractant, such as, pheromone/kairomones. The bait or attractant can be provided at various locations. Two exemplary locations for the bait or attractant include on the adhesive surface of the sliding elements and on the flat central area 2. In FIG. 4, the attractant 35 on the central flat area can be replaced after a period of time.

When the bait or attractant is near the heating element 33, the heat coming from the heating element helps the emission of the attractant or bait.

The bait or attractant is anything that can attract bed bugs to the trap. But it is not necessary. For example, when the trap is used as a bedpost, there is no need to supply attractants to attract the bed bugs to the bed.

In order to prevent bed bugs from climbing out of the trapping area and help the user to easily watch if any bed bugs are caught, another example of bed bug trap is shown in FIGS. 5 and 6. As shown in FIGS. 5 and 6, the bottom surface of each trapping area is smooth and sloping. The points B are the lowest point and the points A are the highest point of each trapping area. For the trapping area that trap bed bugs from the outer wall, the bottom surface of the trapping area slopes down from two of the highest points A near the dividers to one of the lowest point B, which is the middle point of the trapping area. The lowest point B could be at any point of the trapping area. For the trapping area that can trap bed bugs from the inner wall, the bottom surface of the trapping area slopes down from one of the highest point A to two of the lowest points B. Those two of the lowest points B are near the dividers and the highest point A is the middle point of the trapping area. (Of course, the highest point can be any point of the trapping area.) To keep the depth of the trapping channel the same, the heights of the inner wall and outer wall are changed according to the declination of the bottom surface, as shown in FIG. 6. But it is not necessary. The heights of the inner wall and outer wall could be the same. When bed bugs are caught at the trapping areas, they slide down from the highest points A to the lowest points B of each trapping area. Since the bottoms of the trapping areas are smooth, they are trapped at those lowest points. By the design of the sloping and smooth bottom of the trapping areas, bed bugs caught in the trap are accumulated to those lowest points B, which are at the same side of the bed bug trap. When the trap is used for receiving bedpost (not shown) or other similar furniture element, it is easy and convenient to watch whether bed bugs are trapped. It can also prevent caught bed bugs from escaping.

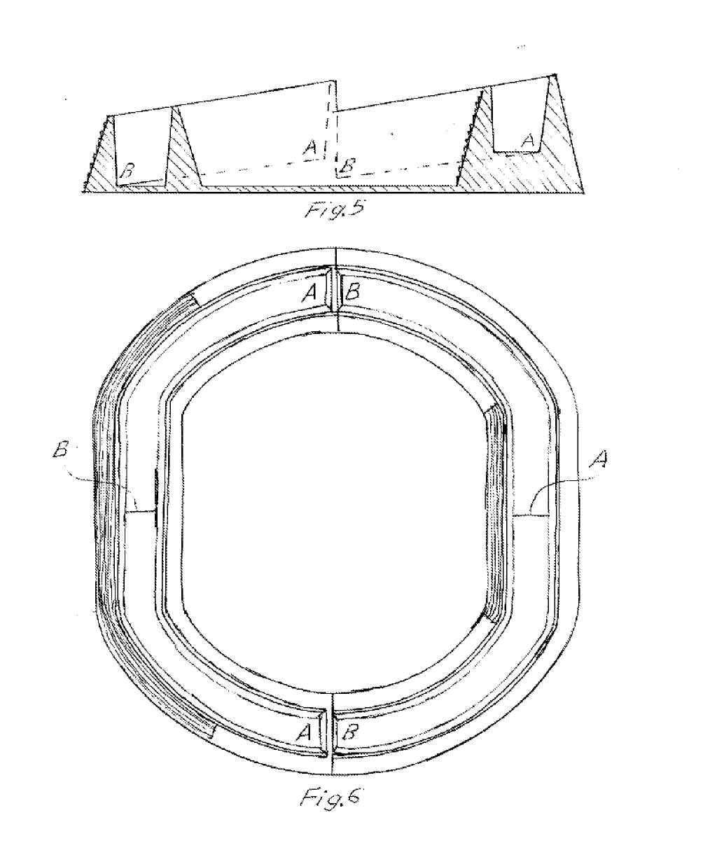

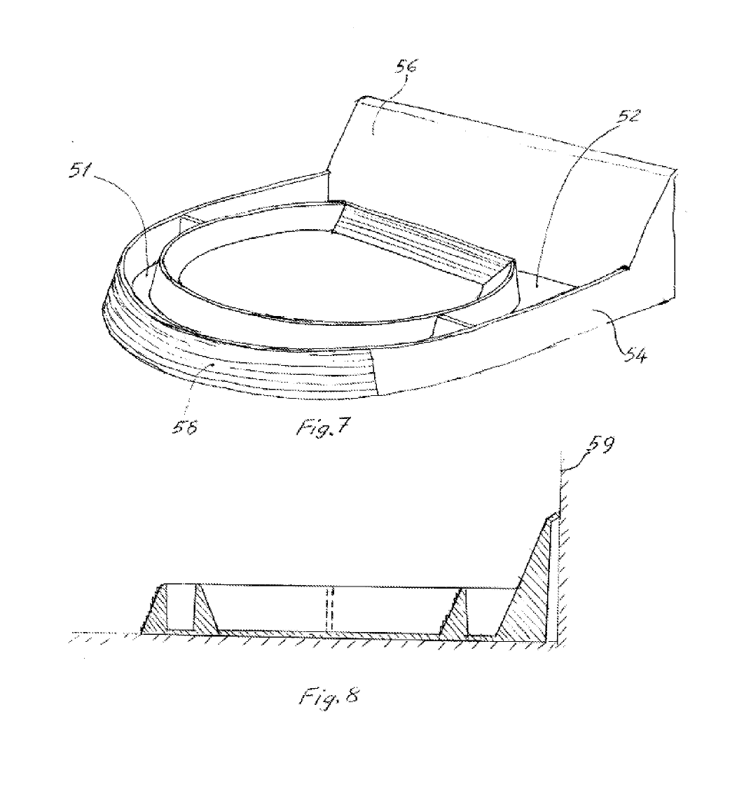

Above embodiments of the bed bug traps are shown as holder for the bed post or one of the legs of any furniture item. But it is not necessary. As shown in FIGS. 7-8, another example of bed bug traps that is designed for attachment to a vertical surface of a frame of a bed or any other furniture. To attach vertically to a surface of the frame, the outer wall 54 has a flat part 56 that can be attached to the vertical surface 59 of a frame of a bed or furniture with no gap. It can be attached to the vertical surface with any normal means, such as glue or mechanical connection. The surface of the flat part 56 is smooth enough that bed bugs that climb here along the frame of a bed or furniture can only fall down to one of the trapping area of the trap, namely trapping area 52 as illustrate. On the other side, the outer surface of the outer wall 54 has a textured surface 58 that is only adjacent to one of the trapping areas, namely trapping area 51 as illustrated. The rest of the outer wall is smooth. Bed bugs approaching the trap from a surrounding floor area may climb the textured surface 58 in an attempt to get to the bed or other furniture, and then fall into the trapping area 51 and are unable to escape. Thus, if a bed bugs is found in that trapping area 51, the user knows that the bed bugs came from outside the trap, i.e. from the surrounding floor, via the textured surface 58. The inner surface of outer wall 54 (including the flat part 56) is smooth enough. If the bed bugs reach the flat part 56 by coming down the vertical surface 59 of the frame of a bed or other furniture, the bed bugs may fall into the trapping area 52. Thus, if a bed bugs are found in trapping area 52, they must have come via the vertical surface 59 and flat part 56, and it must come from the bed or furniture.

The trap shown in FIGS. 7 and 8 can also be used as the bed post trap, wherein the central part can be used for the legs of the bed or other furniture.

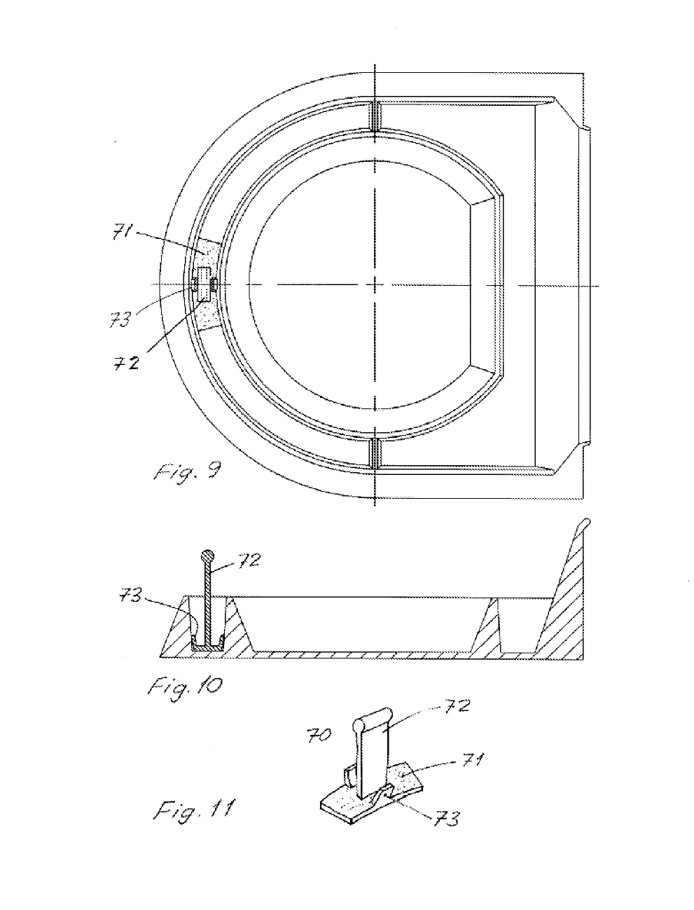

In order to prevent the bed bugs climbing out of the trapping area, sticky glue pad or glue clip can be provided to cover the bottom area of the trap or part of the bottom area of the trap. As shown in FIGS. 9-11, a glue clip 70 is shown attached to the bottom of a trapping area. It has a flat bottom 71, which is sticky or is covered with a glue pad; it has two flexible ribs 73, which can be against the wall when the clip is pressed down and it can fix the glue clip 70 at the bottom of the trapping area. A handle 72 is at the middle of the glue clip 70, which can be used to push/pull the glue clip in or out of the trap. Even though only one glue clip is shown in the FIGS. 9-11, it could be more than one. The shape of glue clip can be vary. By using glue clips, trapped bed bugs can't run away and it is also easy to remove bed bugs from the trap.

Many variations on the preferred embodiment(s) described above are conceivable within the broad scope of the invention. It should therefore be understood that the claims which define the invention are not restricted to the specific embodiment(s) described above.

1. A bed bug trap having at least two separate trapping areas, and at least one textured surface climbable by bed bugs corresponding to each trapping area, at least two said textured surfaces corresponding to separate bed bugs sources, whereby the presence of bed bugs in a particular trapping area indicates which textured surface the bed bugs climbed, and therefore which source the bed bugs came from.

2. A bed bug trap as in claim 1, having a generally flat central area, and inner and outer walls surrounding the central area and defining an annular channel between said inner and outer walls, said annular channel having dividers dividing said channel into at least two trapping areas, each said trapping area having an associated said textured surface for bed bugs to climb.

3. A bed bug trap as in claim 2, wherein at least a portion of each trapping area includes sticky means to capture bed bugs.

4. A bed bug trap as in claim 3, wherein said sticky means comprises at least one removable glue clip.

5. A bed bug trap as in claim 2, wherein at least one trapping area has a bottom surface sloped toward an accumulation area within the trapping area.

6. A bed bug trap as in claim 5, wherein at least a portion of each trapping area includes sticky means to capture bed bugs.

7. A bed bug trap as in claim 6, wherein said sticky means comprises at least one removable glue clip.

8. A bed bug trap as in claim 2, wherein each said trapping area has an elevated platform surface, with the area beneath each platform surface having a lower surface spaced below it and sealed to the trap such that there is a sealed passageway between the platform surface and the lower surface, said platform surfaces each having at least one hole therethrough, such that bed bugs may fall through said holes into said sealed passageway.

9. A bed bug trap as in claim 8, further comprising removable sliding elements slidable into and removable from said, said sliding elements carrying sticky means to capture bed bugs.

10. A bed bug trap as in claim 9, further comprising a chemical bed bug attractant carried on said sliding elements.

11. A bed bug trap as in claim 1, further comprising means for attracting bed bugs to said trap.

12. A bed bug trap as in claim 11, wherein said attracting means comprises at least one selected from the group consisting of: (1) heat generating means, (2) chemical attractant means, and (3) carbon dioxide generation means.

13. A bed bug trap as in claim 2, wherein the outer wall of the trap has a flat part that can be attached to a vertical surface of a bed or furniture with no gap, the surface of the flat part being smooth enough that bed bugs attempting to climb can only fall down into one of the trapping areas of the trap.
